(19) United States
(12) Patent Application Publication
(10) Pub. No.: US 2026/0060242 A1
(43) Pub. Date: Mar. 5, 2026

(54) PEST CONTROL COMPOSITION COMPRISING A HYDROTROPIC SALT

(71) Applicant: THE PROCTER & GAMBLE COMPANY, Cincinnati, OH (US)

(72) Inventors: Sean Michael RENOCK, Loveland, OH (US); Travis Kyle HODGDON, Cincinnati, OH (US); Michael David O'Young MUI, Mason, OH (US); Luke Ryan BRAKE, Morrow, OH (US); Marco CAGGIONI, Cincinnati, OH (US)

(21) Appl. No.: 19/259,409

(22) Filed: Jul. 3, 2025

Related U.S. Application Data
(60) Provisional application No. 63/688,450, filed on Aug. 29, 2024.
(60) Provisional application No. 63/782,096, filed on Apr. 2, 2025.

(51) Int. Cl. A01N 25/30; A01N 31/02; A01N 43/90; A01N 65/22

(52) U.S. Cl. CPC A01N 25/30; A01N 31/02; A01N 43/90; A01N 65/22

(57) ABSTRACT

A pest control composition includes from about 4 wt % to about 10 wt % of sodium lauryl sulfate, from about 1 wt % to about 8 wt % of a C5 to C9 hydrotropic salt, an active ingredient comprising menthol, and from about 60 wt % to about 95 wt % water. The pest control composition can be non-Newtonian and have a first viscosity of from about 15 cP to about 1,500 cP at a shear rate of 1 sec⁻¹ measured at 15° C. and a second viscosity of from about 1 cP to about 50 cP at a shear rate of 500 sec⁻¹ measured at 15° C.

### CROSS REFERENCE TO RELATED APPLICATIONS

This application claims the benefit, under 35 U.S.C. § 119 (c), to U.S. Provisional Application Nos. 63/688,450 filed Aug. 29, 2024, and 63/782,096 filed Apr. 2, 2025, the entire disclosure of which is fully incorporated by reference herein.

### FIELD OF THE INVENTION

The present disclosure relates to a pest control composition and to methods for controlling pests, including plant pests and arthropod pests. More particularly, the disclosure relates to a pest control composition comprising a hydrotropic salt and menthol that exhibits phase stability across a range of temperatures and is efficacious in controlling pests while still being suitable for spraying.

### BACKGROUND OF THE INVENTION

The market for pest control products, such as weed control products and arthropod pest control products, is growing due to factors such as an increase in urban housing, changes in weather patterns, an increase in home food gardening, and the desire to keep lawns, flower beds, etc. looking neat and attractive. At the same time, there is increasing consumer demand for products, e.g., insecticides and/or herbicides, that are natural. Some consumers prefer products that contain a limited number of ingredients and/or recognizable ingredients, as communicated by simpler ingredient statements. In addition, consumers still expect these natural products to be efficacious and efficiently control pests, such as weeds and/or arthropods, comparable to traditional chemical pest control products. However, current natural pest control products are often unstable at cold temperatures and/or provide an unpleasant consumer experience, such as by requiring a consumer to shake the product before use and/or by appearing cloudy or off color.

Increasing the viscosity of an aqueous pest control product has advantages for phase and/or chemical stability. It is believed that as viscosity increases, phase separation (such as liquid-liquid phase separation or precipitation) and/or loss of volatile organic compounds over time may be slowed and/or prevented. Viscosity is commonly increased using high molecular weight (e.g., greater than 1,000 g/mol) polymeric thickeners or gums. However, these materials may leave an unwanted residue on treated surfaces and may clog the nozzle of spraying devices after drying, making it difficult for consumers to spray the product. In addition, high viscosity products can be difficult to spray using standard spraying devices.

There is a need for an effective pest control composition that contains fewer and/or natural ingredients that has a viscosity dependent on shear rate and/or temperature to aid in phase stability across a broad range of temperatures yet is still sprayable.

### SUMMARY OF THE INVENTION

To solve the problems advanced above, the present disclosure provides an aqueous pest control composition that comprises a hydrotropic salt, a surfactant, and an active ingredient comprising menthol. It was surprisingly found that combining menthol with a balanced ratio of hydrotropic salt to surfactant can create a pest control composition that can effectively damage and/or inhibit the growth of plant foliage and roots yet is phase stable across a range of temperatures and has a viscosity that is suitable for spraying. Without being limited by theory it is believed that menthol, a cyclic organic alcohol, in combination with a hydrotropic salt have sufficient amphiphilic character to partition into the interface of the surfactant in a way that modifies the surfactant microstructure. It is believed that this modified microstructure has colloidal length, size and/or interactions that are able to influence the flow properties of the bulk composition similar to thickening polymers but without the need for high molecular weight compounds. It is believed that the surfactant microstructure imparts a shear thinning behavior to the composition where the viscosity is lower at higher shear rates. Further, it was surprisingly found that the viscosity of the pest control composition thickens substantially at lower temperatures as compared to a surfactant microstructure that was not modified with a hydrotropic salt and menthol.

Described herein is a pest control composition comprising: (a) from about 4% to about 10% by weight of the pest control composition of sodium lauryl sulfate; (b) from about 1% to about 8% by weight of the pest control composition of a C5 to C9 hydrotropic salt; (c) an active ingredient comprising menthol; and (d) from about 60% to about 95% by weight of the pest control composition of water; wherein the composition is non-Newtonian.

Also described herein is a pest control composition comprising: (a) from about 4% to about 10% by weight of the pest control composition of sodium lauryl sulfate; (b) from about 1% to about 8% by weight of the pest control composition of a C5 to C9 hydrotropic salt; (c) cornmint oil; and (d) from about 60% to about 95% by weight of the pest control composition of water. The pest control composition exhibits a ratio of a first viscosity at a shear rate of 1 sec⁻¹ to a second viscosity at a shear rate of 500 sec⁻¹ measured at 15° C. of at least 1.5.

### DETAILED DESCRIPTION OF THE INVENTION

Currently marketed pest control products that are labeled as “natural” or containing “plant-based ingredients” have limited efficacy, are often messy to use, are unstable at cold temperatures, and/or provide an unpleasant and/or inconsistent consumer experience, such as by requiring a consumer to shake the product before use, by appearing off color, and/or by exhibiting an unpleasant odor. Described herein is a stable aqueous pest control composition comprising one or more plant essential oils (including synthetic analogues) and/or one or more components or constituents of plant essential oils that is efficacious against a variety of pests, including a variety of plants and arthropods. As used herein, “stable” refers to a pest control composition that is a single substantially clear or translucent phase free from visually observable phase separation, creaming or precipitation, where no agitation or mixing is required to use the pest control composition for its application.

It was surprisingly found that by adding a hydrotropic salt to an aqueous composition comprising a surfactant, a composition comprising a unique lyotropic liquid crystalline microstructure can be created. Without being limited by theory, it is believed that the hydrotropic salt(s) can help the surfactant form a self-assembled lyotropic liquid crystalline microstructure that allows the active ingredient to be more bioavailable and helps to create wetting properties that allow the composition to spread over the target pest, which can improve efficacy and/or speed of action of the pest control composition. It was further surprisingly found that when the active ingredient comprises menthol, the menthol can impact the surfactant microstructure in a way that creates temperature dependent shear thinning properties which can help to provide phase stability across a wide range of temperatures (e.g., from about 5° C. to about 54° C.).

Features and benefits of the various embodiments of the present invention will become apparent from the following description, which includes examples of specific embodiments intended to give a broad representation of the invention. Various modifications will be apparent to those skilled in the art from this description and from practice of the invention. The scope is not intended to be limited to the particular forms disclosed and the invention covers all modifications, equivalents, and alternatives falling within the spirit and scope of the invention as defined by the claims.

As used herein, articles such as “a” and “an” when used in a claim, are understood to mean one or more of what is claimed or described.

As used herein, “contacting” refers to treating, applying, spraying, wetting, soaking, dousing, dipping, immersing, sprinkling, wiping, daubing, spreading, splattering, smearing, etc., any pests such as weeds, portions of weeds, arthropods, etc., desired to be killed, removed, destroyed, defoliated, exterminated, eradicated, eliminated, etc., with the pest control composition described herein.

As used herein, “effective amount” refers to an amount of the pest control composition, which is effective to noticeably kill, remove, destroy, defoliate, exterminate, eradicate, eliminate, etc., pests (e.g., insects, weeds) when those pests are contacted with the pest control composition.

As used herein, the terms “include”, “includes” and “including” are meant to be non-limiting.

As used herein, “lyotropic liquid crystalline microstructure” refers to a self-assembled structure comprising a surfactant that exhibits some degree of repeat microstructural order similar to a solid crystal. In some examples, the repeat spacing of the lyotropic liquid crystalline microstructure may be of a length scale, in at least one dimension, short enough that it is capable of impeding, retarding, slowing, or otherwise altering the free molecular reorientation of water. Examples of lyotropic crystalline microstructures can include structures formed in a sponge phase, lamellar phase, cubic phase, hexagonal phase, nematic phase, and combinations thereof. It is to be appreciated that micelle (spherical, worm-like, and/or branched) and/or uni-lamellar vesicles are surfactant aggregate structures that are not considered to be lyotropic liquid crystalline microstructures.

As used herein, the term “natural oils” means oils that are derived from plant or algae matter. Natural oils are not based on kerosene or other fossil fuels.

As used herein, “pest control” means the management of a pest species, including any animal, such as insects and other arthropods, plant, or fungus that adversely impacts human activities or the environment, where management includes controlling, killing, eliminating, repelling, or attracting the pest species. Pest control products and compositions may include products and compositions for managing a pest species inside and outside of a building, such as a dwelling or a business, including, but not limited to, areas such as garages, patios, balconies, screened porches, lawns, and/or gardens. Pest control products and compositions may include products and compositions for use in and/or on yards, lawns, bushes, trees, and/or outdoor plants, as well as for use on or around indoor plants. Pest control products and compositions may include selective and non-selective products and compositions, such as selective and non-selective herbicides, fungicides, and insecticides. Pest control products and compositions may also include products and compositions for topical application to humans to control or repel pest species, such as insects and other arthropods.

The terms “pest control” and “pesticide” are used interchangeably and it is understood that a composition or an ingredient that has “cidal” activity, e.g., pesticide, insecticide, herbicide, fungicide, may or may not kill and/or eliminate the target pest, e.g., arthropod, insect, weed, or fungus. As used herein, “cide” and “cidal” includes compositions, compounds, components, ingredients, materials, etc., which are effective to kill, remove, destroy, defoliate, exterminate, eradicate, eliminate, etc., a target pest, as well as to retard, regulate, inhibit, prevent, etc., the survival, growth, and/or proliferation of such pest.

As used herein, “substantially free of” or “substantially free from” refers to either the complete absence of an ingredient or a minimal amount thereof merely as impurity or unintended byproduct of another ingredient. A composition that is “substantially free” of/from a component means that the composition comprises less than about 0.05%, or less than about 0.025%, or less than about 0.010%, or less than about 0.005%, or less than about 0.0025%, or less than about 0.001%, by weight of the composition of the component.

As used herein, “weed” refers to the common meaning of the term as any herbaceous plant, vegetation, foliage, grasses, etc., which is deemed to be undesirable or undesired, for example, as encumbering the ground, as hindering, stifling, overwhelming, etc., the growth of what is deemed desired or more desirable plant, vegetation, foliage, grasses, etc. Weeds for which the herbicide composition are effective against may include one or more of: broadleaf weeds such as dandelions, clover, plantain, chickweed, undesired grasses (e.g., crabgrass), moss, other common weeds, etc. Volatile Organic Compounds (VOCs) are identified by the U.S. Environmental Protection Agency (EPA) as organic compounds that participate in atmospheric photochemical reactions, with the exception of compounds that have negligible photochemical reactivity. VOCs are generally emitted as gases from certain solids or liquids. EPA regulations define a chemical as “VOC-exempt” if it has vapor pressure of less than 0.1 millimeters of mercury (at 20° C.). If the vapor pressure is unknown, a chemical is defined as “VOC-exempt” if it: a) consists of more than 12 carbon atoms; or b) has a melting point higher than 20° C. and does not sublime (i.e., does not change directly from a solid into a gas without melting).

The compositions of the present disclosure can comprise, consist essentially of, or consist of, the essential components as well as optional ingredients described herein. As used herein, “consisting essentially of” means that the composition or component may include additional ingredients, but only if the additional ingredients do not materially alter the basic and novel characteristics of the claimed compositions or methods.

Unless otherwise noted, all component or composition levels are in reference to the active portion of that component or composition, and are exclusive of impurities, for example, residual solvents or by-products, which may be present in commercially available sources of such components or compositions.

All percentages and ratios are calculated by weight unless otherwise indicated. All percentages and ratios are calculated based on the total composition unless otherwise indicated. It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

All weights, measurements and concentrations herein are measured at 25 degrees Celsius (C) and 50% relative humidity, unless otherwise specified.

### Pest Control Composition

In some aspects, the pest control composition is in the form of a liquid. The pest control composition may be an aqueous composition.

The pest control composition disclosed herein may comprise less than about 15 ingredients, or less than about 10 ingredients, or less than about 15 ingredients and greater than about 5 ingredients.

The pest control composition of the present disclosure may comprise renewable components. The pest control composition may comprise from about 1%, or from about 5%, or from about 10%, or from about 20%, or from about 30%, or from about 40%, or from about 50% to about 40%, or to about 50%, or to about 60%, or to about 70%, or to about 80%, or to about 90%, or to about 100%, by weight of renewable components. The compositions disclosed herein may be at least partially or fully bio-based. As such, the composition can comprise a bio-based carbon content of about 50% to about 100%, or about 70% to about 100%, or about 75% to about 100%, or about 80% to about 100%, or about 90% to about 100%. The percent bio-based carbon content can be calculated as the “percent Modern Carbon (pMC)” as derived using the methodology of ASTM D6866-16. The compositions of the present disclosure may be substantially free of petroleum-derived solvents or petroleum-derived surfactants.

The compositions disclosed herein may comprise ingredients listed under section 25 (b) of the Federal Insecticide, Fungicide, and Rodenticide Act (FIFRA), incorporated herein by reference in its entirety. The compositions disclosed herein may comprise naturally occurring compounds or extracts or derivatives thereof. The compositions disclosed herein may comprise at least one organic, certified organic, US Department of Agriculture (“USDA”) National Organic Program compliant (“NOP-compliant”) ingredient. The compositions disclosed herein may comprise at least one ingredient that is food grade or generally recognized as safe (GRAS). The GRAS ingredient may include any agent listed on the FDA's GRAS list, including direct food additives (scc, e.g., US law (sections 201 (s) and 409 of the Federal Food, Drug, and Cosmetic Act, November 2016). The GRAS ingredient may also include, but is not limited to, agents that are generally recognized, among experts qualified by scientific training and experience to evaluate their safety, as having been adequately shown through scientific procedures (or, in the case of a substance used in food prior to Jan. 1, 1958, through either scientific procedures or through experience based on common use in food) to be safe. The use of food grade or GRAS ingredients can enable the compositions disclosed herein to be used by consumers without rinsing a treated surface after use. The compositions disclosed herein may comprise ingredients that have a tolerance or tolerance exemption for use on food contact surfaces under the Federal Food, Drug, and Cosmetic Act US law (see, e.g., 40 CFR 180, November 2016, December 2015 update).

### Water

Aqueous liquid compositions are convenient to use because these compositions can be readily applied directly to arthropod pests or weeds, while leaving minimal residue on adjacent surfaces. The pest control compositions may be substantially free of a geologically derived (e.g., petroleum-based) carrier oils, such as mineral oil, and/or a vegetable oil as products containing a carrier oil or vegetable oil may be messy to use and may leave a residue on a treated surface.

The pest control compositions may comprise from about 40% to about 99%, or from about 45% to about 98%, by weight of the composition of water. The pest control composition may comprise from about 40% to about 97% water, or from about 60% to about 95%, or from about 50% to about to about 92%, or from about 70% to about to about 90%, or from about 55% to about 83%, or from about 78% to about 80%, or from about 58% to about 78%, or from about 60% to about 75%, or from about 62% to about 72%, all by weight of the pest control composition.

### Active Ingredients

The pest control composition may comprise one or more active ingredients (also referred to herein as actives). In some aspects, the pest control composition may comprise from about 0.005% to about 30%, or from about 0.005% to about 25%, or from about 0.05% to about 20%, or from about 0.15% to about 18%, or from about 0.15% to about 15%, or from about 0.5% to about 12%, or from about 0.5% to about 10%, by weight of the composition of one or more active ingredients. In some aspects, the pest control composition may comprise from about 0.5% to about 12%, or from about 1% to about 10%, or from about 3% to about 8%, or from about 4% to about 7%, by weight of the composition of the one or more active ingredients.

Suitable active ingredients may include plant oils/essential plant oils (including synthetic analogues) and/or constituents thereof (including synthetic analogues). In some aspects, the active ingredient may be a natural oil. Examples of active ingredients include aldehyde C16 (pure), almond oil, alpha-terpineol, verbenone, alpha-cedrene, cinnamic aldehyde, amyl cinnamic aldehyde, cinnamyl acetate, amyl salicylate, anisic aldehyde, cedrol, benzyl acetate, cinnamaldehyde, cinnamic alcohol, carvacrol, carveol, citral, citronellal, citronellol, dimethyl salicylate, eucalyptol (also known as 1,8-cineole), thujopsene, 3-thujopsanone, alpha-thujone, beta-thujone, fenchone, eugenyl acetate (e.g., isoeugenyl acetate), d-limonene, linalool, alpha-pinene, tetrahydrolinalool, ethyl cinnamate, eugenol, iso-eugenol, methyl iso-eugenol, galaxolide, geraniol, guaiacol, ionone, menthol (e.g., L-menthol), menthone, carvone (e.g., L-carvone), camphor, p-cymene, bornyl acetate, isobornyl acetate, gamma-terpinene, methyl anthranilate, methyl ionone, methyl salicylate, nerol, alpha-phellandrene, pennyroyal oil, perillaldehyde, 1- or 2-phenyl ethyl alcohol, 1- or 2-phenyl ethyl propionate, piperonal, piperonyl acetate, piperonyl alcohol, D-pulegone, terpinen-4-ol, terpinyl acetate, 4-tert butylcyclohexyl acetate, thymol, trans-anethole, vanillin, ethyl vanillin, castor oil, cedar oil, cinnamon, cinnamon oil, citronella, citronella oil, clove, corn oil, cornmint oil, cottonseed oil, garlic, garlic oil, linseed oil, mint, mint oil, thyme, peppermint, peppermint oil, spearmint, spearmint oil, rosemary, sesame, sesame oil, soybean oil, white pepper, licorice oil, wintergreen oil, star anise oil, lilac flower oil, black seed oil, grapefruit seed oil, grapefruit, lemon oil, orange oil, tea tree oil, tagete minuta oil, lavender oil, lippia javancia oil, oil of bergamot, galbanum oil, lovage oil, and combinations thereof.

Examples of essential oils can include thyme (thymol, carvacrol), oregano (carvacrol, terpenes), lemon (limonene, terpinene, phellandrene, pinene, citral), orange flower (linalool, β-pinene, limonene), orange (limonene, citral), anise (anethole, safrol), clove (eugenol, eugenyl acetate, caryophyllene), rose (geraniol, citronellol), rosemary (borneol, bornyl esters, camphor), geranium (geraniol, citronellol, linalool), lavender (linalyl acetate, linalool), citronella (geraniol, citronellol, citronellal, camphene), eucalyptus (eucalyptol), peppermint (menthol, menthyl esters), spearmint (carvone, limonene, pinene), wintergreen (methyl salicylate), camphor (safrole, acetaldehyde, camphor), bay (cugenol, myrcene, chavicol), cinnamon (cinnamaldehyde, cinnamyl acetate, eugenol), tea tree (terpinen-4-ol, cineole), cedar leaf (α-thujone, β-thujone, fenchone), geranium (Citronellol, Geraniol, guaiadiene), cornmint (Menthol, Menthone), garlic (dimethyl trisulfide, diallyl disulfide, diallyl sulfide, diallyl tetrasulfide, 3-vinyl-[4H]-1,2-dithiin), and combinations thereof.

In some aspects, the pest control composition may comprise about 0.005% to about 15%, or from about 0.05% to about 15%, or from about 0.15% to about 12%, or from about 0.5% to about 10% of one or more active ingredients selected from the group consisting of eugenol, 2-phenylethyl propionate, menthol, menthone, amyl butyrate, geraniol, limonene (e.g., d-limonene), p-cymene, linalool, linalyl acetate, camphor, methyl salicylate, pinene (e.g., alpha-pinene, beta-pinene), eucalyptol, piperonal, piperonyl alcohol, tetrahydrolinalool, thymol, carvone (e.g., L-carvone), vanillin, ethyl vanillin, iso-eugenol, bornyl acetate, isobornyl acetate, terpinene (e.g., gamma-terpinene), cinnamyl acetate, cinnamic alcohol, cinnamaldehyde, ethyl cinnamate, pyrethrins, abamectin, azadirachtin, amitraz, rotenone, boric acid, spinosad, biopesticides, synthetic pesticides, and mixtures thereof. In some aspects, the pest control composition may comprise from about 0.05% to about 3%, or from about 0.1% to about 2%, or from about 0.4% to about 1% menthol by weight of the pest control composition.

In some aspects, the active ingredient may be a pesticidal and/or herbicidal active. The pesticidal and/or herbicidal active may be a plant extract, constituent thereof, or synthetic analogue thereof selected from the group consisting of corn mint oil, peppermint oil, spearmint oil, rosemary oil, thyme oil, citronella oil, clove oil, cedarwood oil, cinnamon oil, geranium oil, eugenol, 2-phenylethyl propionate, menthol, menthone, thymol, carvone, camphor, methyl salicylate, p-cymene, linalool, geraniol, cinnamyl acetate, cinnamic alcohol, cinnamaldehyde, citronellol, eucalyptol/1,8-cineole, alpha-pinene, bornyl acetate, gamma-terpinene, and combinations thereof.

In some aspects, the active ingredient may be a synthetic pesticide. Examples of synthetic pesticides include pyrethroids, such as bifenthrin, esfenvalerate, fenpropathrin, permethrin, cypermethrin, cyfluthrin, deltamethrin, allethrin, lambda-cyhalothrin, or the like; syngergists, such as piperonyl butoxide, or the like; juvenile hormone analogues, such as methoprene, hydroprene, kinoprene, or the like; and neonicotinoids, such as imidacloprid, acetamiprid, thiamethoxam, or the like, and mixtures thereof. In some aspects, the pest control composition may comprise less than about 10%, or less than about 5%, or less than about 2%, or less than about 1%, or less than about 0.5%, or less than about 0.1% by weight of the pest control composition of a synthetic pesticide. Alternatively, the pest control composition may be substantially free of a synthetic pesticide.

In some aspects, the active ingredient may comprise one or more biopesticides. Examples of biopesticides include pyrethrum, rotenone, neem oil, and mixtures thereof.

In some aspects, the pest control composition may comprise an essential oil comprising menthol, such as cornmint oil and/or peppermint oil, and an additional active chosen from rosemary oil, thyme oil, citronella oil, clove oil, cinnamon oil, cedarwood oil, garlic oil, geranium oil, lemongrass oil, eugenol, geraniol, nerol, vanillin, 2-phenylethyl propionate, menthol, menthone, thymol, carvone, camphor, methyl salicylate, p-cymene, linalool, eucalyptol/1,8-cineole, alpha-pinene, bornyl acetate, gamma-terpinene, or mixtures thereof, preferably chosen from geraniol, rosemary oil, thyme oil, lemongrass oil, citronella oil, and mixtures thereof. In some aspects, the pest control composition may comprise an active ingredient wherein the active ingredient is a plant extract, constituent thereof, or synthetic analogue thereof selected from the group consisting of cornmint oil, peppermint oil, menthol, geraniol, and combinations thereof.

In some aspects, the pest control composition may comprise from about 0.1% to about 7.5% cornmint oil and from about 1% to about 6% geraniol, all by weight of the pest control composition. It is believed that cornmint oil (menthol) may improve the low temperature stability of compositions containing anionic surfactants, such as SLS.

### Surfactant

The pest control composition may be formulated with one or more surfactants. The pest control composition may comprise from about 1% to about 12%, or from about 4% to about 10%, or from about 6% to about 8%, by weight of the pest control composition of one or more surfactants, preferably one or more anionic surfactants.

A sprayed drop of a pest control composition is preferably able to wet a target surface and spread out or cover a target area to perform its intended function. A surfactant generally reduces the surface tension of the water on the surface of the spray drop by reducing the interfacial tension between the spray drop and target surface, e.g., the surface of the weed. Surfactants also wet and disperse particles of active ingredient(s) in the composition prior to spraying, thereby enabling more uniform coverage and wetting of the target weed upon spraying. Surfactants may also function to emulsify hydrophobic active agents that are not easily solubilized in water, such as oils. Surfactants thus include various agents known to function as emulsifiers or wetting agents. Suitable surfactants include anionic surfactants, amphoteric surfactants, zwitterionic surfactants, nonionic surfactants, cationic surfactants, or mixtures thereof.

Anionic surfactants are surfactant compounds that contain a long chain hydrocarbon hydrophobic group in their molecular structure and a hydrophilic group, including salts such as carboxylate, sulfonate, sulfate or phosphate groups. The salts may be sodium, potassium, calcium, magnesium, barium, iron, ammonium and amine salts of such surfactants. Anionic surfactants include the alkali metal, ammonium and alkanol ammonium salts of organic sulfuric reaction products having in their molecular structure an alkyl or alkaryl group containing from about 8 to about 22 carbon atoms and a sulfonic or sulfuric acid ester group. Examples of such anionic surfactants include water soluble salts and mixtures of salts of alkyl benzene sulfonates having from about 8 to about 22 carbon atoms in the alkyl group (e.g., linear alkyl benzene sulfonates, such as dodecylbenzene sulfonate and salts thereof), alkyl sulfates and alkali metal salts thereof (e.g., sodium dodecyl sulfate), alkyl ether sulfates having from about 8 to about 22 carbon atoms in the alkyl group and about 2 to about 9 moles of ethylene oxide. Aryl groups generally include one or two rings, alkyl groups generally include from about 8 to about 22 carbon atoms, and ether groups generally comprise from about 1 to about 9 moles of ethylene oxide (EO) and/or propylene oxide (PO), preferably EO.

A preferred anionic surfactant is sodium lauryl sulfate or “SLS” (also known as sodium dodecyl sulfate). The pest control composition may comprise from about 4% to about 10%, or from about 6% to about 8%, by weight of the pest control composition of sodium lauryl sulfate. In some aspects, the pest control composition may comprise a surfactant consisting essentially of sodium lauryl sulfate.

Anionic surfactants may also include fatty acids and salts thereof. Fatty acids and salts thereof are organic molecules comprising a single carboxylic acid moiety (carboxylate anion in salts) and at least 7 carbon atoms, or from about 11 to about 22 carbon atoms, or from about 12 to about 16 carbon atoms. The salts of fatty acids are also known as soaps and the counter ions of the salts may be sodium, potassium, calcium, magnesium, barium, iron, ammonium and amine salts of fatty acids. Fatty acid and the salts thereof may be linear, branched, saturated, unsaturated, cyclic, or mixtures thereof. Examples of fatty acids and salts thereof include octanoic acid, nonanoic acid, decanoic acid, lauric acid, myristic acid, palmitic acid, stearic acid, arachidic acid, behenic acid, lignoceric acid, myristoleic acid, palmitoleic acid, sapienic acid, oleic acid, elaidic acid, vaccenic acid, linoleic acid, linoelaidic acid, arachidonic acid, eicosapentaenoic acid, erucic acid, docosahexaenoic acid, the sodium, calcium, potassium or zinc salts thereof, or mixtures thereof.

Additional suitable anionic surfactants include alkyl sulfosuccinates, alkyl ether sulfosuccinates, olefin sulfonates, alkyl sarcosinates, alkyl monoglyceride sulfates and ether sulfates, alkyl ether carboxylates, paraffinic sulfonates, acyl methyl taurates, sulfoacetates, acyl lactates, and sulfosuccinamides.

Alternatively, the pest control composition may be substantially free of fatty acids, as a fatty acid may be difficult to solubilize in an aqueous composition. In particular, the pest control composition may be substantially free of lauric acid, oleic acid, stearic acid, or a combination thereof.

The pest control composition may comprise one or more active ingredients, such as one or more hydrophobic active ingredients (such as a natural oil or a constituent thereof), and surfactant, preferably an anionic surfactant, more preferably sodium lauryl sulfate. The weight ratio of surfactant to total active ingredient may be from about 1:3 to about 30:1, or about 1:3 to about 20:1, or about 1:1 to about 30:1, or about 1:1 to about 20:1, or about 1:1 to about 10:1, or about 1:1 to about 5:1, or about 1:3 to about 3:1, or about 1:2 to about 2:1, or about 1:1.5 to about 1.5:1, or about 1:1.2 to about 1.2:1. It has been surprisingly found that if the ratio of total (hydrophobic) active ingredient to sodium lauryl sulfate is too high, there may not be enough sodium lauryl sulfate to solubilize the (hydrophobic) active ingredient, particularly over a range of temperatures from about 5° C. to about 40° C. temperatures. If the hydrophobic active ingredient is not sufficiently emulsified, then a layer of the hydrophobic ingredient, e.g., oil, may form on top of the composition, causing the composition to appear turbid. However, if the ratio of hydrophobic active ingredient to sodium lauryl sulfate is too low, then there may be too much free sodium lauryl sulfate, which may precipitate at cold temperatures.

The pest control composition may comprise an amphoteric surfactant, a zwitterionic surfactant, a nonionic surfactant, or a mixture thereof (in addition to or instead of an anionic surfactant). Amphoteric surfactants are surface active agents containing at least one anionic group and at least one cationic group and may act as either acids or bases, depending on pH. Some of these compounds are aliphatic derivatives of heterocyclic secondary and tertiary amines, in which the aliphatic substituent(s) may be straight or branched, at least one of the aliphatic substituents contains from about 6 to about 20, or from about 8 to about 18, carbon atoms, and at least one of the aliphatic substituents contains an anionic water-solubilizing group, e.g., carboxy, phosphonate, phosphate, sulfonate, sulfate.

Zwitterionic surfactants are surface active agents having a positive and negative charge in the same molecule, where the molecule is zwitterionic at all pHs. Zwitterionic surfactants include betaines and sultaines. The zwitterionic surfactants generally contain a quaternary ammonium, quaternary phosphonium, or a tertiary sulfonium moiety. Zwitterionic surfactants contain at least one straight chain or branched aliphatic substituent, which contains from about 6 to 20, or from about 8 to about 18, carbon atoms, and at least one aliphatic substituent containing an anionic water-solubilizing group, e.g., carboxy, sulfonate, sulfate, phosphate or phosphonate.

Examples of suitable amphoteric and zwitterionic surfactants include the alkali metal, alkaline earth metal, ammonium or substituted ammonium salts of alkyl amphocarboxyglycinates and alkyl amphocarboxypropionates, alkyl amphodipropionates, alkyl monoacetate, alkyl diacetates, alkyl amphoglycinates, and alkyl amphopropionates, where the alkyl group has from 6 to about 20 carbon atoms. Other suitable amphoteric and zwitterionic surfactants include alkyliminomonoacetates, alkyliminidiacetates, alkyliminopropionates, alkyliminidipropionates, and alkylamphopropylsulfonates, where the alkyl group has from about 12 to about 18 carbon atoms, as well as alkyl betaines, alkylamidoalkylene betaines, alkyl sultaines, and alkylamidoalkylenchydroxy sulfonates.

The nonionic surfactant(s) may be any of the known nonionic surfactants, examples of which include condensates of ethylene oxide with a hydrophobic moiety. Nonionic surfactants include ethoxylated primary or secondary aliphatic alcohols having from about 8 to about 24 carbon atoms, in either straight or branch chain configuration, with from about 2 to about 40, or from about 2 and about 9 moles of ethylene oxide per mole of alcohol. Other suitable nonionic surfactants include the condensation products of alkyl phenols having from about 6 to about 12 carbon atoms with about 3 to about 30, or about 5 to about 14 moles of ethylene oxide. Nonionic surfactants also include ethoxylated castor oils and silicone surfactants, such as Silwet L-8610, Silwet L-8600, Silwet L-77, Silwet L-7657, Silwet L-7650, Silwet L-7607, Silwet L-7604, Silwet L-7600, and Silwet L-7280.

The pest control composition may optionally comprise one or more cationic surfactants. Suitable cationic surfactants include quaternary ammonium surfactants and amino surfactants that are positively charged at the pH of the pest control composition.

### Urea

The pest control composition may comprise from about 0.1% to about 10%, or from about 0.5% to about 8%, or from about 1% to about 6%, by weight of the pest control composition of urea. Without wishing to be bound by theory, it is believed that urea may improve the stability, availability, and/or solubility of the one or more active ingredients in the composition, thereby improving the efficacy of the composition without increasing the concentration of VOCs. Further, it is believed that urea may improve the low temperature stability of compositions containing anionic surfactants, such as SLS.

### Solvent

The pest control compositions described herein may comprise from about 0.001% to about 15%, or from about 0.01% to about 12%, or from about 0.1% to about 10%, or from about 0.5% to about 8%, or from about 1% to about 5%, or from about 2% to about 4%, by weight of the pest control composition of a solvent. Liquid pest control compositions may comprise one or more solvents and water.

Suitable solvents include alcohols, such as monohydric or polyhydric alcohols. Preferred monohydric alcohols are low molecular weight primary or secondary alcohols exemplified by ethanol, propanol, and isopropanol, preferably isopropanol. Polyhydric alcohols, such as those containing from 2 to about 6 carbon atoms and from 2 to about 6 hydroxy groups (e.g., ethylene glycol, glycerin, and 1,2-propanediol (also referred to as propylene glycol)), may also be used.

Suitable solvents also include esters. The pest control composition may comprise from about 0.005% to about 15%, or from about 0.05% to about 12%, or from about 0.5% to about 10%, or from about 1% to about 7%, by weight of the pest control composition of one or more esters. Examples of suitable esters include triethyl citrate, diethyl citrate, monoethyl citrate, isopropyl myristate, myristyl myristate, isopropyl palmitate, octyl palmitate, isopropyl isothermal, butyl lactate, ethyl lactate, butyl stearate, triethyl citrate, glycerol monooleate, glyceryl dicaprylate, glyceryl dimyristate, glyceryl dioleate, glyceryl distearate, glyceryl monomyristate, glyceryl monooctanoate, glyceryl monooleate, glyceryl monostearate, decyl oleate, glyceryl stearate, isocetyl stearate, octyl stearate, putty stearate, isostearyl neopentonate, PPG myristyl propionate, diglyceryl monooleate, and diglyceryl monostearate. The pest control composition may comprise triethyl citrate, preferably from about 1% to about 10%, or from about 4% to about 8%, all by weight of the pest control composition.

Additional solvents include lipophilic fluids, including siloxanes, other silicones, hydrocarbons, glycol ethers, glycerin derivatives such as glycerin ethers, perfluorinated amines, perfluorinated and hydrofluoroether solvents, low-volatility nonfluorinated organic solvents, diol solvents, and mixtures thereof.

Suitable solvents listed under section 25 (b) of the Federal Insecticide, Fungicide, and Rodenticide Act (FIFRA) include butyl lactate (including enantiomers thereof), vinegar, 1,2-propylene carbonate, isopropyl myristate, ethyl lactate (including enantiomers thereof), isopropyl alcohol, and glycerin.

Preferred solvents include isopropanol, triethyl citrate, ethanol, glycerin, ethyl lactate, renewable versions thereof, and mixtures thereof. The pest control compositions described herein may comprise a solvent selected from the group consisting of isopropanol, triethyl citrate, and mixtures thereof. In some aspects, the pest control composition may comprise from about 1% to about 3% by weight of the pest control composition of isopropyl alcohol. In some aspects, the pest control composition may comprise less than about 2.5% by weight of the pest control composition of glycerin. In some aspects, the pest control composition is substantially free of glycerin.

### pH Adjusting Agents

The pest control composition may comprise a buffer system. The buffer system may comprise one or more pH adjusting agents, such as an acid. The buffer system may comprise an acid (such as citric acid and/or acetic acid) and its conjugate base (such as a salt of citric acid and/or acetic acid). When the pest control composition comprises a buffer system, the acid may be citric acid or acetic acid and the conjugate base may be a sodium salt of the respective acid.

The pest control compositions may comprise from about 0.00001% to about 5%, or from 0.01% to about 5%, or from about 0.1% to about 4%, or from about 1% to about 3.5%, by weight of the composition of a pH adjusting agent, such as a carboxylic acid or a salt thereof, e.g., citric acid or a salt thereof. In some aspects, the pest control compositions may comprise from about 0.0001% to about 3%, or from about 0.001% to about 1.5%, or from about 0.01% to about 1%, or from about 0.1% to about 0.6%, by weight of the composition of a pH adjusting agent, such as a carboxylic acid or a salt thereof, e.g., citric acid or a salt thereof. Non-limiting examples of pH adjusting agents may include malic acid, citric acid, fumaric acid, humic acid, acetic acid, monosodium citrate, sodium citrate, disodium citrate, trisodium citrate, trisodium citrate dehydrate, trisodium citrate pentahydrate, sodium acetate, or combinations thereof. The pH adjusting agent may be selected from the group consisting of citric acid or a salt thereof, malic acid or a salt thereof, acetic acid or a salt thereof, fumaric acid or a salt thereof, humic acid or a salt thereof, and mixtures thereof, preferably citric acid or a salt thereof, more preferably citric acid anhydrous or citric acid monohydrate. Preferably, the pH adjusting agent is selected from the group consisting of sodium citrate, citric acid, sodium acetate, acetic acid, and combinations thereof. Carboxylic acids, such as citric acid, or salts thereof may also function as chelants.

### Hydrotropic Salt

The pest control composition may comprise one or more hydrotropic salts. As used herein, a hydrotropic salt is the salt of a monovalent, C5-C9 organic acid. Without wishing to be bound by theory, it is believed that a hydrotropic salt, unlike an inorganic salt, will selectively partition into and consequently modify the self-assembled surfactant microstructure. Salts with fewer than five carbon atoms, such as acetic acid, are highly water soluble and have little or no impact on the surfactant self-assembled microstructure as they reside predominantly in the water phase. Inorganic salts (e.g., salts without carbon atoms) such as sodium chloride are fully water soluble and will not partition into the surfactant self-assembled microstructure. Salts with more than nine carbon atoms may act as a co-surfactant to modify the surfactant self-assembled structure into other surfactant aggregate structures. It is believed that hydrotropic salts with five to nine carbon atoms and a monovalent organic acid moiety have sufficient balance between hydrophobicity and hydrophilicity to partition into a surfactant self-assembled microstructure and can help to create lyotropic liquid crystalline microstructures.

In some aspects, the hydrotropic salt may be a C5-C9 hydrotropic salt, preferably a C6-C7 hydrotropic salt. The organic moiety may be aliphatic or aromatic, saturated or unsaturated and linear or branched. In some aspects, the organic moiety is unsaturated and branched. The acid moiety may be a carboxylic acid or a sulfonic acid.

Examples of monovalent, C5-C9 organic carboxylic acids can include valeric acid, isovaleric acid, 2-methylbutiric acid, pivalic acid, beta-hydroxyvaleric acid, gamma-hydroxyvaleric acid, beta-hydroxy beta-methylbutyric acid, alpha-furoic acid, tetrahydrofuroic acid, caproic acid, dimethylbutanoic acid, sorbic acid, enanthic acid, cyclohexanecarboxylic acid, benzoic acid, salicylic acid, dimethylpentanoic acid, 2-ethyl-3-methylbutanoic acid, octanoic acid, methylheptanoic acid, dimethylhexanoic acid, ethanchexanoic acid, octenoic acid, nonanoic acid, and cinnamic acid. Examples of monovalent, C5-C9 organic sulfonic acids can include benzene sulfonic acid, butyl monoglycol sulfonic acid, toluene sulfonic acid, xylene sulfonic acid, and cumene sulfonic acid. Examples of suitable cations for the hydrotropic salt can include sodium, potassium, calcium, magnesium, ammonium, and combinations thereof. In some aspects, the cation may be sodium and/or potassium.

Particularly suitable hydrotropic salts can include salts of benzoic acid, salts of sorbic acid, salts of octanoic acid, and mixtures thereof. In some aspects, the hydrotropic salt may be selected from potassium benzoate, ammonium benzoate, calcium benzoate, sodium benzoate, magnesium benzoate, potassium sorbate, sodium sorbate, magnesium sorbate, ammonium sorbate, calcium sorbate, calcium octanoate, potassium octanoate, sodium octanoate, and mixtures thereof.

In some aspects, when the hydrotropic salt is a salt of benzoic acid, the pest control composition may comprise from about 1% to about 15%, or from about 3% to about 13%, or from about 5% to about 10%, of the hydrotropic salt. In some aspects, when the hydrotropic salt is a salt of sorbic acid, the pest control composition may comprise from about 1% to about 5%, or from about 1.5% to about 3%, or from about 2% to about 2.5%, of the hydrotropic salt.

In some aspects, it may be preferable to use a combination of hydrotropic salts such that total hydrotropic salt is from about 1% to about 6%, or from about 1.5% to about 5%, or from about 2% to about 4%, by weight of the pest control composition. In some aspects, the pest control composition may comprise a salt of benzoic acid and a salt of sorbic acid. When both a salt of benzoic acid and a salt of sorbic acid are used, the weight ratio of salt of benzoic acid to salt of sorbic acid may be from about 1:3 to about 3:1. It was surprisingly found that having a ratio of salt of benzoic acid to salt of sorbic acid outside of this range can lead to a microstructure that is not phase stable.

The pest control composition may comprise a ratio of hydrotropic salt to surfactant, preferably sodium lauryl sulfate, of from about 0.15 to about 0.9, or from about 0.3 to about 0.9, or from about 0.4 to about 0.8. If the ratio of hydrotropic salt to surfactant is too high, it is believed that the hydrotropic salt will dominate the interfacial behavior and destroy the lyotropic liquid crystalline microstructure. If the ratio of hydrotropic salt is too low, it is believed that there may be insufficient influence to create a lyotropic liquid crystalline microstructure and the self-assembled microstructure will remain a surfactant aggregate, such as a micelle.

The pest control composition may comprise a ratio of hydrotropic salt to active ingredient, preferably essential oil, of from about 0.15 to about 1.0, or from about 0.2 to about 1.0, or from about 0.3 to about 0.9.

The pest control composition described herein may be a non-selective burn-down herbicide. It was surprisingly found that the addition of potassium sorbate and/or sodium benzoate can boost the herbicidal activity of the composition by effectively damaging and/or inhibiting the growth of the roots, thus helping to prevent or delay regrowth of the plant. When potassium sorbate is solubilized in the composition, the potassium ions readily dissociate. It is hypothesized that elevated levels of potassium ions in the composition, when delivered to the plant and soil, may lead to cationic antagonism, thereby inhibiting the uptake of other vital nutrients like magnesium and calcium by the plant roots. Another mechanism of action hypothesized for potassium sorbate is water starving. Water starving can occur when a high salt concentration delivered outside of the root pulls water away from the root resulting in poor water uptake. When sodium benzoate is solubilized in the composition, the sodium ions readily dissociate. It is hypothesized that the free sodium ions aid in plant dehydration by retaining available water. Additionally, the sodium ions may reduce the uptake of nutrients such as potassium, magnesium, and calcium through cationic antagonism mechanisms within the plant. These disruptions of key mechanisms can result in delayed or inhibited plant growth.

While inorganic salts like sodium chloride are known to improve efficacy of some pest control compositions, it was surprisingly found that adding sodium chloride to the context of the pest control composition described herein disrupted the unique microstructure and resulted in phase separation. In some aspects, the pest control composition may be substantially free of chloride ions.

The pest control composition described herein comprises a microstructure with a hydrodynamic equivalent diameter of from about 10 nm to about 50 nm, or about 15 nm to about 45 nm, or about 22 nm to about 40 nm, as measured according to Hydrodynamic Equivalent Diameter Test Method.

The pest control composition may have a receding contact angle of less than about 21 degrees, or from about 0 to about 20 degrees, or from about 0 to about 18 degrees, or from about 0 to about 15 degrees. Without being limited by theory, it is believed that by having a receding contact angle of less than about 21 degrees, the pest control composition can wet the surface of and/or stick to the leaves and/or stems of a weed for a longer period of time (as compared to conventional herbicides), thus allowing more contact time for the pest control composition to act on the weed. It was surprisingly found that the pest control composition described herein can stick and dry onto the stems and/or leaves, leaving a residue of salt crystals which is believed to help with weed control efficacy.

The pest control composition may be subject to fluctuating temperatures during shipping, storage, and/or use. The pest control composition may be stable (clear or translucent and a single phase) at low temperatures (i.e., from about 5° C. to about 10° C.). The pest control composition may also be stable (clear or translucent and a single phase) at 25° C. Maintaining clarity/translucency and phase stability over a range of temperatures below 25° C. may be important for pest control products because they are often stored in areas devoid of temperature control (e.g., garage or shed). In addition, it was found that the pest control composition may be stable at high temperatures (i.e., from about 50° C. to about 55° C.).

The pest control composition may have a relatively high level of clarity (i.e., low turbidity). Some consumers prefer a substantially clear or translucent product versus a product that is cloudy or murky (i.e., higher turbidity). A substantially clear or translucent composition that is a single phase may connote purity, quality, and/or that the composition is not likely to stain surfaces. The composition may exhibit a turbidity of from about 2 NTU to about 40 NTU, or from about 5 NTU to about 35 NTU. Turbidity of the compositions can be measured with a laboratory turbidity meter as described in the Turbidity Method below.

The pest control composition may exhibit a temperature dependent shear thinning behavior. The pest control composition may exhibit a first viscosity of from about 15 cP to about 1,000 cP, or from about 20 cP to about 800 cP, or from about 25 cP to about 600 cP, at a shear rate of 1 sec⁻¹ measured at 22° C. The pest control composition may exhibit a second viscosity of from about 1 cP to about 50 cP, or from about 5 cP to about 40 cP, or from about 10 cP to about 35 cP, at a shear rate of 500 sec⁻¹ measured at 22° C. The pest control composition may exhibit a first viscosity of from about 15 cP to about 1,000 cP at a shear rate of 1 sec⁻¹ measured at 22° C. and a second viscosity of from about 1 cP to about 50 cP at a shear rate of 500 sec⁻¹ measured at 22° C.

It was surprisingly found that the viscosity of the pest control composition thickens substantially at lower temperatures. The pest control composition may exhibit a first viscosity of from about 15 cP to about 1,500 cP, or from about 50 cP to about 1,000 cP, or from about 100 cP to about 800 cP, at a shear rate of 1 sec⁻¹ measured at 15° C. The pest control composition may exhibit a second viscosity of from about 1 cP to about 50 cP, or from about 10 cP to about 40 cP, or from about 15 cP to about 35 cP, at a shear rate of 500 sec⁻¹ measured at 15° C. The pest control composition may exhibit a first viscosity of from about 15 cP to about 1,500 cP at a shear rate of 1 sec⁻¹ measured at 15° C. and a second viscosity of from about 1 cP to about 50 cP at a shear rate of 500 sec⁻¹ measured at 15° C.

The pest control composition may be non-Newtonian (i.e., the viscosity is dependent on shear rate). The pest control composition may exhibit a ratio of the first viscosity to the second viscosity measured at 22° C. of at least 1.5, or from about 2 to about 25, or from about 3 to about 20. The pest control composition may exhibit a ratio of the first viscosity to the second viscosity measured at 15° C. of at least 1.5, or from about 2 to about 30, or from about 10 to about 25. The pest control composition may exhibit a ratio of the first viscosity measured at 15° C. to the first viscosity measured at 22° C. of at least 1.5, or from about 1.75 to 25, or from about 1.8 to about 20. The pest control composition may exhibit a ratio of the second viscosity measured at 15° C. to the second viscosity measured at 22° C. of at least 1.4, or from about 1.5 to 8, or from about 1.5 to about 5.

In some aspects, the pest control composition may be provided in the form of a concentrated composition, which is mixed with a diluent, e.g., water, prior to use, or a ready-to-use composition, which can be directly applied (e.g., as a spray) to pests, such as arthropods and weeds, and need not be diluted by a consumer before use. Ready-to-use compositions may be preferred by some consumers, because ready-to-use compositions do not require dilution by the consumer, which may be messy, inconvenient, and/or require multiple containers. The pest control composition may contain select ingredients at select levels suitable to be sprayed directly onto pests.

The pest control composition may have a pH ranging from about 3.0 to about 11.0, or from about 4.0 to about 11.0, or from about 4.0 to about 9.0, or from about 5.0 to about 9.0, or from about 5.0 to about 8.0, or from about 6.0 to about 8.0, or from about 6.0 to about 7.0. In some aspects, the pest control composition may have a pH of from about 4.8 to about 8.0, or from about 5.0 to about 7.5, or from about 5.5 to about 6.5. In some aspects, the pest control composition may have a pH from about 5.0 to about 6.5.

The pest control composition may be a “low VOC” composition and may comprise about 3% volatile organic compounds (VOCs) by weight or less. Alternatively, the pest control composition may comprise greater than 3% volatile organic compounds (VOCs) by weight. The pest control composition may comprise greater than 3% to about 35% by weight of volatile organic compound (VOC). In some aspects, it may be desirable to keep the total level of VOCs in the pest control composition to less than or equal to about 3% by weight. VOCs can be measured according to the California Air Resources Board (CARB) Method 310 for VOC determination (May 25, 2018).

VOCs may come from one or more ingredients in the composition, including the solvent and/or essential oil. It was found that by changing the level of solvent, particularly isopropyl alcohol, the total level of VOCs in the pest control composition could be maintained at a level of less than or equal to about 35%, or less than or equal to about 20%, or less than or equal to about 10%, or less than or equal to about 3%, while still maintaining a substantially clear or translucent and reduced yellow color or colorless pest control composition. The pest control composition may comprise from about 0.01% to about 3%, or from about 0.1% to about 2.5%, or from about 0.5% to about 2.25%, or from about 1% to about 2%, by weight of the pest control composition of isopropyl alcohol. The levels of isopropanol and/or essential oil in the pest control composition may be selected such that the total VOC level of the pest control composition is from about 0 to about 3% by weight.

The pest control composition may be stored outside or in a garage where it may be subject to fluctuating temperatures, such as daytime and nighttime temperature changes and/or seasonal temperature changes. The pest control composition described herein may be stable at low temperatures (i.e., from about 5° C. to about 10° C.) and at high temperatures (i.e., from about 50° C. to about 55° C.). The pest control composition may have a turbidity of about 20 NTU or less after exposure to low temperatures and/or after recovery to room temperature from cold temperature exposure and a turbidity of about 40 NTU or less after exposure to high temperatures and/or after recovery to room temperature from high temperature exposure.

### Packaging and Dispensing

Also described herein is a pest control product comprising a pest control composition disposed in a container. The pest control compositions described herein may be packaged in any suitable container, including those constructed from paper, cardboard, plastic materials, metal, and any suitable laminates. The container may store from about 50 g to about 5,000 g, or from about 2,000 g to about 5,000 g, or from about 3,000 g to about 5,000 g, or from about 50 g to about 2,000 g, or from about 50 g to about 500 g, or from about 150 g to about 400 g, or from about 200 g to about 350 g of the pest control composition. The container may store from about 400 g to about 8,000 g, or from about 500 g to about 6,000 g, or from about 1,000 g to about 5,000 g, or from about 1,500 g to about 4,000 g of the pest control composition. The weight of the pest control product, including the composition, may be selected to enable a user to comfortably manipulate and actuate the product with one hand, while providing enough composition to treat one or multiple target areas/surfaces of varying sizes, once or multiple times, e.g., multi-use product (e.g., a multi-use product).

The pest control composition may be dispensed in any number of suitable manners, such as spraying, pouring, and the like. The pest control composition may be dispensed by spraying using any number of known spray dispensers, e.g., pump-spray, trigger-spray, aerosol-spray, and the like. The spray dispenser may be attached to a plastic or metal container and may include known components, such as a dip tube, a valve, an actuator, and/or a nozzle for dispensing the composition to the environment. The valve may control flow and/or to seal the composition, such as within a pressurized plastic or metal container. The spray dispenser (e.g., powered spray wand, manual trigger spray) may be connected to the container by a tube or a hose, thereby allowing a user to hold the container in one hand and the spray dispenser in the other hand.

In the case of a pressurized container, in addition to the pest control composition, the container may comprise a propellant. Examples of suitable propellants include compressed gasses, such as nitrogen, carbon dioxide, and air; liquidized hydrocarbons, such as butane, isobutate, and propane; hydrofluoro-olefins, and mixtures thereof. The propellant may be selected from the group consisting of nitrogen, carbon dioxide, and mixtures thereof. The pressurized container may have an internal gage pressure of from about 414 kPa to about 1,100 kPa, or from about 600 kPa to about 1,000 kPa, or from about 700 kPa to about 900 kPa.

As detailed below, in the Spray Droplet Size Test Method, spray droplet volume size distribution measurements comprising Spray D(50) Normalized, Spray D(90) Normalized, and Spray D(2,3) Normalized values are determined using a Malvern Spraytec 2000 laser diffraction spray droplet sizing instrument (supplied by Malvern Instruments, Worcestershire, UK). The pest control composition, when dispensed through a spray dispenser, may have a Spray D(90) ranging from about 100 microns to 900 microns, or from about 125 microns to about 800 microns, or from about 150 microns to about 700 microns. Spray D(90) may be selected to efficiently deliver an active agent to the target surface or area. Also, a Spray D(90) in the disclosed ranges may be perceived as capable of traveling a distance of one or more meters and depositing on a target surface. Particles having a Spray D(90) less than 100 microns may create a spray that is too misty or a spray that does not have sufficient velocity to travel to a target surface.

The spray dispenser may have a spray rate ranging from about 0.5 g/s to about 5 g/s, or from about 0.75 g/s to about 4 g/s, or from about 1.25 g/s to about 3.5 g/s, or from about 1.5 g/s to about 3 g/s. The spray rate may be selected to enable targeted dispensing and delivery of the composition, without over-spraying or spraying composition outside the target area.

Without being bound by theory, it is believed that the pest control products disclosed herein are particularly advantageous for the targeted spraying of pest control compositions (e.g., insecticide or herbicide) from a distance of about 0.3 m to about 1.5 m, or about 0.3 m to about 1 m, from the target pest or surface. The composition (including characteristics such as viscosity and surface tension), the dispensing pressure, and/or the nozzle design may be selected to provide optimal spray exit velocity and particle size distribution (PSD) for spraying a pest control product on the target pest or surface at a distance of about 0.3 m to about 1.5 m, or about 0.3 m to about 1 m, from the target pest or surface.

The pest control composition may be packaged in a container, such as a bottle, that is at least partially transparent or translucent. In some aspects, the container may comprise a transparent portion, such as a window. The transparent or translucent container may have a light transmittance of greater than 25% at wavelength of about 410-800 nm. Container materials that may be used include but are not limited to: polypropylene (PP), polyethylene (PE), polycarbonate (PC), polyamides (PA) and/or polyethylene terephthalate (PET), polyvinylchloride (PVC), and polystyrene (PS).

A transparent or translucent container or a transparent portion of a container may have a light transmittance of greater than 25% at wavelength of about 410-800 nm. A transparent or translucent container may have a light transmittance of more than about 25%, or more than about 30%, or more than about 40%, or more than about 50%, or more than about 60%, or more than about 80%, or more than about 95%, in the visible part of the spectrum (approx. 410-800 nm). Alternatively, absorbency of the container may be measured as less than about 0.6 or by having transmittance greater than about 25%, where % transmittance equals:

$$\frac{1}{{10}^{absorbancy}} \times 100 \%$$

For purposes of the disclosure, as long as one wavelength in the visible light range has greater than about 25% transmittance, it is considered to be transparent/translucent.

A transparent or translucent container may be desirable for housing a clear, colorless, and/or single phase pest control composition, as such a container allows a user to view the contents of the container, which may enable the user to confirm the suitability/useableness of the composition. For example, a user may readily observe the clear, colorless, and/or a single-phase character of the composition at the time of purchase, as well as at a later time point, such as after seasonal (e.g., winter) storage, to confirm the suitability/useableness of the composition. And, if the user observes that the composition is no longer clear or has separated into multiple phases, the user may take steps to restore the clear or single-phase character of the composition, e.g., by shaking, mixing, and/or changing the ambient temperature of the composition.

### Method for Making a Pest Control Composition

The present disclosure also relates to processes for making a pest control composition comprising hydrotropic salt.

In some aspects, the components to form a pest control composition can be added in the following order: water, hydrotropic salt(s), surfactant(s), solvent(s), and active ingredient(s). In some aspects, pH adjusting agent(s) can be added at various steps of the process to reach the desired target pH. In some aspects, a second hydrotropic salt may be added after the addition of the active ingredient(s) and prior to adjusting the pH to the target pH.

It is believed that changing the order of addition of the formulation components may alter the rheology and/or cause degradation of certain components. In order to minimize the risk of degradation and to maintain the desired rheology, it may be preferable to add the components in the following order: water, sodium benzoate, sodium lauryl sulfate, optionally citric acid, triethyl citrate, isopropyl alcohol, active ingredient(s), trisodium citrate, and potassium sorbate. Additional citric acid may optionally be added reach the desired target pH. In some aspects, a first portion of citric acid may be added after the surfactant to lower the pH in order to reduce the degradation of triethyl citrate. Without being limited by theory, it is believed that if the order of addition of the formulation components is modified, a pest control composition may be formed which contains an undesirable level and/or presence of degradation products such as citric acid, ethanol, sorbic acid, acetaldehyde, beta carboxylacrolein, crotonaldehyde, and/or acetone.

In some aspects, a method of forming a pest control composition can comprise the steps of:
a. mixing water, a first hydrotropic salt, and a surfactant to form a first mixture;
b. optionally mixing a first pH adjusting agent with the first mixture to reduce the pH, preferably to a pH of less than about 6.5;
c. mixing one or more solvents and one or more active ingredients with the first mixture to form a second mixture; and
d. mixing a second pH adjusting agent and an optional second hydrotropic salt with the second mixture to form a pest control composition comprising a lyotropic liquid crystalline microstructure, wherein the pH of the pest control composition is from about 5.0 to about 6.5.

The method can be performed at ambient temperature.

In some aspects, the process for making a pest control composition may comprise the steps of: a. combining sodium lauryl sulfate, an active ingredient, and an optional solvent, to make an active ingredient premix; b. combining the active ingredient premix with an aqueous phase comprising water, urea (if present), a hydrotropic salt, and optionally, a pH adjusting agent, to form the pest control composition; wherein the pest control composition has a pH of about 3.0 to about 11.0, preferably from about 5.0 to about 6.5, wherein the pest control composition comprises a lyotropic liquid crystalline microstructure as described herein.

### Methods for Controlling Weeds

The present disclosure also relates to methods for controlling undesired weeds. In some aspects, the method for controlling weeds can comprise the steps of: (a) providing a pest control composition (e.g., an herbicide composition); and (b) contacting the weeds with an effective amount of the pest control composition. The pest control composition may dry on the surface of the leaves and/or stem of the weeds.

Another aspect of the present disclosure includes methods of providing one or more yard and garden benefit comprising (a) providing the present pest control composition and (b) contacting a target plant with an effective amount of the pest control composition. As used herein, the one or more yard and garden benefit may be chosen from killing plant roots and/or leaves; killing broadleaf and grassy weeds; killing weeds in landscape areas, raised beds, gardens, and cracks in pavers and/or walkways; providing visible results in one hour; providing crabgrass control; killing the entire weed (roots and leaves); helping to prevent regrowth; killing moss; killing roots in a single treatment; or combinations thereof.

The pest control composition may be applied (e.g., by spraying as an aqueous liquid) onto a target area in an amount in the range of from about 0.5 to about 40 ml/ft, alternatively from about 0.9 to about 36 ml/ft.

The pest control composition may be administered to leaves and/or stems of the target weed. When sprayed on a weed, it is believed that the pest control composition can adhere to the surface of the leaves and/or stems, resulting in burn down of the plant photosystem. It was found that after drying on the weed, the pest control composition can form a visible white precipitate comprising the hydrotropic salt on the surface of the leaves and/or stems. Without being limited by theory, it is believed that rain, moisture in the air, and/or water from sprinklers can dissolve the precipitate, allowing the salt ions to get in the soil around the weed and pull water away from the roots, thus disrupting the growth of and/or killing the roots.

The pest control composition, e.g., herbicide, may be used to inhibit the growth and/or development of weeds, such as for example dandelion, milk thistle, broadleaf plantain, white clover, green foxtail, redroot pigweed, yellow nutsedge, crabgrass, evening primrose, chickweed, common bermudagrass, morning glory, wild carrot, Italian ryegrass, umbrella sedge, or ivy. The pest control composition, e.g., herbicide, may be used to treat existing weeds or may be used prevent weed growth. In the latter case, the pest control composition, e.g., herbicide, may be used as a pre-emergent pest control. The pest control composition may be used for non-selective pest control.

The pest control composition, e.g., herbicide, may be used to control weeds that grow from a variety of surfaces. For example, the pest control composition, e.g., herbicide, may be sprayed on hard surfaces with openings containing dirt where weeds may be present or may develop, such as asphalt, concrete, interlocking bricks, roads, and highways. The pest control composition, e.g., herbicide, may be applied to vegetable gardens, lawns, golf course greens, or flower beds, where weeds may be present or may develop.

The pest control composition, e.g., herbicide, may be applied as a single treatment or as multiple treatments, such as application on consecutive days or weeks.

### Method of Controlling an Arthropod Pest

The present disclosure also relates to methods for controlling undesired arthropods, such as insects. In some aspects, the method of controlling an arthropod pest may comprise the steps of: (i) providing a pest control composition (e.g., an insecticide composition); (ii) contacting a target area, surface, and/or arthropod pest with the pest control composition(s) as described herein; (iii) optionally wiping any excess pest control composition from an adjacent surface(s). The arthropod pest may be contacted with an effective amount of the pest control composition. The optional wiping of an adjacent surface(s) may provide a cleaning benefit on the surface, due to the presence of a surfactant, such as sodium lauryl sulfate, in the composition. Optionally, the adjacent surface may be left to dry, without wiping or rinsing.

The pest control composition, e.g., insecticide, may be applied as a single treatment or as multiple treatments, such as application on consecutive days or weeks.

### EXAMPLES

The following data and examples are provided to help illustrate the pest control compositions described herein. The exemplified compositions are given solely for the purpose of illustration and are not to be construed as limitations of the present invention, as many variations thereof are possible without departing from the spirit and scope of the invention. All parts, percentages, and ratios herein are by weight unless otherwise specified.

### Example 1—Effect of Hydrotropic Salt on Temperature Stability and Receding Contact Angle

A series of formulas were prepared to understand the impact of hydrotropic salt on the temperature stability and receding contact angle of the formulation. Samples A-L were made according to the procedure described above. Temperature stability was assessed according to the Temperature Stability method described hereafter. Receding Contact Angle was assessed according to the Receding Contact Angle (RCA) Method described hereafter.

Samples A-L were made according to the following formulas.

TABLE 1

| | A | B | C | D | E | F |
|---|---|---|---|---|---|---|
| Ingredient | (wt %) | (wt %) | (wt %) | (wt %) | (wt %) | (wt %) |
| Sodium Lauryl | 6.50 | 6.50 | 7.00 | 6.00 | 7.00 | 6.00 |
| Sulfate (SLS) | | | | | | |
| Cornmint Oil¹ | 1.00 | — | 1.00 | 1.00 | 1.00 | 1.00 |
| Geraniol² | 4.85 | 4.85 | 4.85 | 3.88 | 4.85 | 3.88 |
| Spearmint³ | — | 1.00 | — | — | — | — |
| Potassium | — | — | 0.07 | 0.02 | 0.70 | 0.20 |
| Sorbate | | | | | | |
| Sodium Benzoate | — | 0.07 | — | 0.04 | — | 0.40 |
| Urea | 5.00 | 5.00 | — | — | — | — |
| Triethyl Citrate | 6.50 | 6.50 | 7.00 | 5.50 | 7.00 | 5.50 |
| Isopropyl Alcohol | 2.70 | 3.00 | 2.70 | 2.00 | 2.70 | 2.00 |
| Citric Acid | 0.05 | 0.07 | 0.04 | 0.05 | 0.07 | 0.06 |
| Trisodium Citrate | 0.25 | 0.25 | 0.25 | 0.25 | 0.25 | 0.25 |
| DI Water | QS | QS | QS | QS | QS | QS |
| Ratio of Total | 0.00 | 0.01 | 0.01 | 0.01 | 0.10 | 0.10 |
| Hydrotropic Salt | | | | | | |
| to SLS (HS:SLS) | | | | | | |
| Ratio of Total | 0.00 | 0.01 | 0.01 | 0.01 | 0.12 | 0.12 |
| Hydrotropic Salt | | | | | | |
| to Active | | | | | | |
| Ingredient (HS:O) | | | | | | |
| Phase Stability at | Pass | Fail | Fail | Pass | Fail | Fail |
| 2 wks at 5° C. | | | | | | |
| Phase Stability at | Fail | Pass | Pass | Fail | Pass | Fail |
| 2 wks at 54° C. | | | | | | |
| Receding Contact | 21.3 | 26.3 | 26.3 | 12.6 | 14 | 22.3 |
| Angle (Degrees) | | | | | | |
| | G | H | I | J | K | L |
| Ingredient | (wt %) | (wt %) | (wt %) | (wt %) | (wt %) | (wt %) |
| Sodium Lauryl | 6.50 | 7.00 | 6.00 | 6.50 | 6.50 | 6.50 |
| Sulfate | | | | | | |
| Cornmint Oil¹ | — | 1.00 | 1.00 | — | — | — |
| Geraniol² | 4.85 | 4.85 | 3.88 | 4.85 | 4.85 | 4.85 |
| Spearmint³ | 1.00 | — | — | 1.00 | 1.00 | 1.00 |
| Potassium | — | 2.50 | 1.00 | — | — | — |
| Sorbate | | | | | | |
| Sodium Benzoate | 0.65 | — | 3.00 | 5.00 | 6.50 | 13.00 |
| Urea | 5.00 | — | — | 5.00 | 5.00 | 5.00 |
| Triethyl Citrate | 6.50 | 7.00 | 5.50 | 6.50 | 6.50 | 6.50 |
| Isopropyl Alcohol | 3.00 | 2.70 | 2.00 | 3.00 | 3.00 | 3.00 |
| Citric Acid | 0.16 | 0.17 | 0.24 | 0.16 | 0.23 | 0.16 |
| Trisodium Citrate | 0.25 | 0.25 | 0.25 | 0.25 | 0.25 | 0.25 |
| DI Water | QS | QS | QS | QS | QS | QS |
| Ratio of Total | 0.10 | 0.40 | 0.70 | 0.80 | 1.00 | 2.00 |
| Hydrotropic Salt | | | | | | |
| to SLS (HS:SLS) | | | | | | |
| Ratio of Total | 0.11 | 0.40 | 0.80 | 0.90 | 1.11 | 2.22 |
| Hydrotropic Salt | | | | | | |
| to Active | | | | | | |
| Ingredient (HS:O) | | | | | | |
| Phase Stability at | Pass | Pass | Pass | Pass | Pass | Pass |
| 2 wks at 5° C. | | | | | | |
| Phase Stability at | Fail | Pass | Pass | Pass | Pass | Pass |
| 2 wks at 54° C. | | | | | | |
| Receding Contact | 18.6 | 14.3 | 12.3 | 18.6 | 22.3 | 26.6 |
| Angle (Degrees) | | | | | | |

¹Available from Ventos (Kenilworth, NJ).
²Available from BASF (Beaumont, TX).
³Available from Ventos (Kenilworth, NJ).

Table 1 shows that by properly balancing the ratio of hydrotropic salt to surfactant, a composition can be formed that exhibits phase stability across a range of temperatures (i.e., 5° C. to 54° C.) and a receding contact angle of less than about 21 degrees. Without being limited by theory, it is believed that a pest control composition having a receding contact angle of less than about 21 degrees will wet the surface of the pest more effectively and thus allows for more contact time between the composition and target pest which may help improve efficacy.

Sample A, which is a control that does not include a hydrotropic salt, exhibited a receding contact angle of 21.3 degrees and was phase stable at 5° C. (i.e., the sample is clear and single phase) but unstable at 54° C. (i.e., the sample contains phase separation). A product comprising a phase unstable composition may be undesirable to consumers as the product may require repeated shaking. This can be inconvenient to a consumer and is an additional step that consumers may not perform as instructed which could impact efficacy.

Samples B, C, and D have a ratio of hydrotropic salt to SLS (HS:SLS) and a ratio of hydrotropic salt to active ingredient (HS:O) of 0.01. Samples B and C exhibited a receding contact angle greater than Sample A of 26.3 degrees and were not phase stable at 5° C. Sample D exhibited a receding contact angle lower than Sample A of 12.6 degrees, but was phase unstable at 54° C. Samples E, F, and G have an HS:SLS ratio and HS:O ratio of 0.10. Samples E and G exhibited a receding contact angle lower than Samples A of 14.0 and 18.6 degrees, respectively. However, Samples E and F were phase unstable at 5° C. and Samples F and G were phase unstable at 54° C.

Samples H, I, and J include a hydrotropic salt and have an HS:SLS ratio of 0.40, 0.70, and 0.80, respectively, and an HS:O ratio of 0.40, 0.80, 0.90, respectively. Samples H, I, and J were phase stable at both 5° C. and 54° C. and had a receding contact angle of less than 21 degrees. It is believed that the level of hydrotropic salt, surfactant, and essential oil of Samples H, I, and J is uniquely balanced such that the hydrotropic salt can interact with the surfactant and oil to create a lyotropic liquid crystalline structure that influences the receding contact angle (which allows the compositions to better stick to a pest) without negatively impacting the phase stability of the composition across a range of temperatures (i.e., 5° C. to 54° C.).

Samples K and L have an HS:SLS ratio of 1.0 and 2.0, respectively, and an HS:O ratio of 1.1 and 2.2, respectively. Samples K and L were phase stable at 5° C. and 54° C.; however, the receding contact angle was greater than 21 degrees. It is believed that Samples K and L may not be able to sufficiently wet the surface of the pest.

### Example 2—Viscosity

Samples A, H, I, and J were further assessed to understand the impact of hydrotropic salt on viscosity as a function of temperature and shear rate. Samples A, H, I, and J were made as described above according to the formulas in Table 1. Viscosity was measured according to the Viscosity Test Method described hereafter.

TABLE 2

| Temp | Shear Rate | Viscosity (cP) | | | |
|---|---|---|---|---|---|
| (° C.) | (sec⁻¹) | Sample A | Sample H | Sample I | Sample J |
| 22 | 1 | 7.0 | 27.7 | 287.0 | 9.2 |
| 22 | 500 | 6.8 | 8.8 | 16.0 | 6.8 |
| 15 | 1 | 10.0 | 427.0 | 569.0 | 9.7 |
| 15 | 500 | 8.7 | 29.5 | 26.1 | 8.9 |

It was found that the viscosity of Sample A, which contains menthol (cornmint oil) but has no hydrotropic salt, has little dependency on shear rate or temperature. It was surprisingly found that Sample H and I, which contain menthol (cornmint oil) and a hydrotropic salt, exhibited a relatively strong dependency of viscosity on both temperature and shear rate. The viscosity of Sample J, which contains carvone (spearmint oil) and a hydrotropic salt, was found to be only weakly dependent on temperature and shear rate. Without being limited by theory, it is believed that menthol may uniquely be able to impact the structure of the composition to create temperature dependent and sheer thinning behavior. It was surprisingly found that carvone is not able to sufficiently impact the structure of the composition to create temperature dependent or sheer thinning behavior. It is believed that temperature and/or shear rate dependent viscosity may be advantageous for stability and spraying characteristics of a pest control composition. Particularly suitable pest control compositions may exhibit a first viscosity of from about 15 cP to about 1,000 cP at a shear rate of 1 sec⁻¹ measured at 22° C. and a second viscosity of from about 1 cP to about 50 cP at a shear rate of 500 sec⁻¹ measured at 22° C. Particularly suitable pest control compositions may further exhibit a third viscosity of from about 15 cP to about 1,500 cP at a shear rate of 1 sec⁻¹ measured at 15° C. and a fourth viscosity of from about 1 cP to about 50 cP at a shear rate of 500 sec⁻¹ measured at 15° C.

### Test Methods

### Viscosity Test Method

Viscosity as a function of temperature and shear rate is measured using a suitable rheometer such as a Discovery HR 30 (available from TAR Instruments, New Castle, Del.) or equivalent fitted with a 40 mm stainless steel 1 degree cone and plate geometry. The rheometer with geometry is calibrated according to manufactures instructions prior to measurements. Samples are loaded, trimmed and fitted with a solvent trap to minimize evaporation. Samples are brought to within +0.5° C. of target temperature and subsequently equilibrated at zero shear rate and +0.5° C. of target temperature for two minutes. The sample is sheared at 1 sec⁻¹ for two minutes with viscosity data recorded every second and the viscosity at target temperature and a shear rate of 1 sec⁻¹ is the average of the last thirty data points recorded. The sample is subsequently sheared at a rate of 500 sec⁻¹ for two minutes with viscosity data collected every second and the viscosity at target temperature and a shear rate of 500 sec⁻¹ is the average of the last 30 data points recorded.

### pH Test Method

pH is measured using a standard pH meter such as, for example, a Beckman Coulter model PHI1410 pH meter equipped with a general-purpose probe (manufactured by Beckman Coulter, Brea, California, U.S.A.). The pH meter is calibrated according to the manufacturer's instructions.

Measurements are performed after storing the compositions at room temperature (approximately 23° C.±2° C.) for approximately 24 hours.

### Hydrodynamic Equivalent Diameter Test Method

Dynamic light scattering (DLS) is used to measure particle size using a Malvern Zetasizer Nano ZEN3600 system (www.malvern.com) with a He—Ne laser 633 nm, or equivalent. The autocorrelation function is analyzed using the Zetasizer Software provided by Malvern Instruments, which determines the effective hydrodynamic radius, using the Stokes-Einstein equation:

$$D = \frac{{k}_{B} T}{6 πη R}$$

where, k_{B} is the Boltzmann Constant, T is the absolute temperature, η is the viscosity of the medium, and D is the mean diffusion coefficient of the scattering species, and R is the hydrodynamic radius of particles.

Particle size (i.e. hydrodynamic radius) is obtained by correlating the observed speckle pattern that arises due to Brownian motion and solving the Stokes-Einstein equation, which relates the particle size to the measured diffusion constant, as is known in the art.

The measurement angle is 173° and a refractive index of 1.46 is used for surfactant aggregate structures. The count rate for the measurement is between 200-400 kcps. All samples are kept at 25° C., unless otherwise specified.

For each sample composition, two specimen replicates are measured in this way, and the arithmetic mean of the resulting Z-average values is reported as the Hydrodynamic Equivalent Diameter in nanometers (nm) to the nearest 0.1 nm.

### Spray Droplet Size Test Method

The term “Dv10 value” describes the average particle size where 10 vol. % of the particles have a smaller size. Similarly, the term “Dv50 value” describes the average particle size where 50 vol. % of the particles have a smaller size, and the term “Dv90 value” describes the average particle size where 90 vol. % of the particles have a smaller size. The Sauter mean diameter (D [3, 2]) is the weighted average surface diameter, assuming spherical particles of the same surface area as the actual particles:

$$D [ 3 , 2 ] = \frac{\sum {D}_{1}^{2} {n}_{i}}{\sum {D}_{i}^{2} {n}_{i}} .$$

Spray droplet volume size distribution measurements comprising Spray D(50) Normalized, Spray D(90) Normalized, and Spray D(2,3) Normalized values are determined using a Malvern Spraytec 2000 laser diffraction spray droplet sizing instrument (supplied by Malvern Instruments, Worcestershire, UK), equipped with a 300 mm lens possessing a focal length of the 150 mm, and an Air Purge System (not greater than 14.5 psi). The system is controlled with a computer and software accompanying the instrument, such as the Spraytec software version 3.20 or equivalent, utilizing Mie Theory and Fraunhofer Approximation optical theory. The system is placed in a fume hood for atmospheric control with care taken to place it directly opposite the actuation spray plume trajectory to prevent saturation, with an air flow rate of between 50-70 L/min (60 L/min was the target rate). The distance from the dispensing nozzle orifice to the laser during measurements is 30 cm. A new spray bottle is used for each sample replicate analyzed. Lighting conditions are not changed during or between the background control and test sample data collection periods. Light obscuration values below 95% are considered suitable to provide accurate results.

Samples analyzed included “example” samples, which are samples according to this disclosure, and comparative samples. All newly created example samples are tested within three hours of preparation and are measured at temperatures between 20-22° C. Deionized water is used as a standard reference spray and is labeled as the “control.”

Spray measurements are conducted using the following spray SOP instrument configuration: Rapid SOP type is chosen, and the following settings are selected: Hardware Configuration is set to “Default”, Measurement Type is set to “Rapid”, Data Acquisition Rate is set to “250 Hz”, and Lens Type is set to “300”. Within the Measurement menu: Background is set to “3 seconds”, Inspection is selected, the box under Output Trigger is Unchecked. Under the Measurement tab “Rapid” is selected, Events Number is set to “1”, Duration Per Event is set to “4000.0”, Units is set to “ms”. Measurement Trigger where Trigger Type is set to “Transmission drops to level” and Transmission is set to “96”, Data Collection where Start is set to “52”, Units is set to “ms”, and select “before the trigger” from the drop down menu. On the Advanced tab window, all boxes are Unchecked, and Grouping is “no grouping”; The Background Alarms are set to “default values”. On the Analysis Tab and under Optical Properties, Particle Set is set to “Water”, Dispersant set to “Air”, Multiple Scattering Analysis is set to “Enable”. On the Data Handling tab and under Detector Range is set to “first: 1 and last: last”, “No extinction analysis” box is selected, Scattering threshold is set to “1”. On the Data Handling/Spray Profile the Path Length is set to “100.0”, the Alarm is selected, and the “Use default values” box is checked. On the Additional Properties tab the Curve Fit is set to “no fit”, User Size is set to “enable box”, the drop down menu is set to “Default”. On the Additional Properties/Advanced tab Particle Diameter is set to “0.10” for the minimum and to “900” for the maximum, and Result Type is set to “Volume Distribution”. On the Output tab, Export Option is set to “not selected”, the Derived Parameter is selected, the Use Averaging Period box is selected and set to “0.0” and “ms”. On the Average menu “Average scatter data” is selected.

Spray measurements are conducted using the following Spray Procedure: The sample is first test sprayed from the spray bottle for 1-2 seconds, to ensure that the nozzle is free flowing and not clogged; the sample is loaded into the holding device in the front of the Spraytec 2000 system. The actuator is fully depressed. The spray droplet size data are viewed and saved as “Average Scatter Data”.

The value obtained from each sample measurement is normalized to the control sample value in accordance with the following calculations:

$$\begin{matrix}The value of Spray D ( 50 ) Normalized = {D ( 50 )}_{Example} / {D ( 50 )}_{Control} ; \\ The value of Spray D ( 90 ) Normalized = {D ( 90 )}_{Example} / {D ( 90 )}_{Control} ; \\ The value of Spray D ( 3 , 2 ) Normalized = {D ( 3 , 2 )}_{Example} / {D ( 3 , 2 )}_{Control} ;\end{matrix}$$

wherein:

Spray D(50), Spray D(90), and Spray D(3,2) are values obtained from the instrument software for both the example samples and control samples separately.

Each of the Spray D(90) Normalized and Spray D(3,2) Normalized values reported for each of the samples is the average value calculated from five replicate spray plumes per sample.

### Turbidity Method

A turbidimeter is used to measure the turbidity of the compositions. A suitable turbidimeter is the Hach 2100Q/2100Q is (Hach Company, Loveland, CO, USA), or equivalent. This instrument measures the turbidity of liquids in Nephelometric Turbidity Units (NTU). The method of measuring turbidity is described in detail in the following reference: Hach 2100Q and 2100Q is User Manual, Edition 6, 08/2021, from the Hach Company. If a sample is not homogenous prior to analysis, the sample is repeatedly inverted until it appears homogenous and is then poured into an analyte vile for measurement.

This method of measurement determines quantitative values of turbidity by evaluating the ratio of a primary nephelometric light scatter signal to a transmitted light scatter signal. This particular method of evaluation provides values between 0-1000 NTU, where increasing NTU values indicate more turbid compositions. In between each test sample, water controls may be measured to ensure proper equipment operation. For example, water may have a turbidity of about 1.11 NTU and isopropyl alcohol may have a turbidity of about 0.15 NTU. It is believed that improved emulsification of active ingredients, particularly hydrophobic active ingredients, yields lower NTU values.

### Temperature Stability

Samples are prepared by combining all ingredients in a 4-ounce glass vial at ambient conditions (25 deg. C.). The sample is mixed and, five minutes after mixing is completed, the sample is observed for initial stability.

Cold temperature stability is measured by filling a 4-ounce glass vial with a sample composition. The vial is sealed and stored at 5° C. for two weeks. The vial is then moved to a 25° C. environment and stored for 10 to 12 hours. The vials are then visually observed for phase stability (and may be assessed for turbidity using the Turbidity Method described above). Phase instability is determined when more than one phase is visually apparent, such as a top hazy/milky phase separated from a clear bottom phase or a clear top phase that is separated from a bottom hazy/milky phase. If phase instability is observed, the sample is rated as a “fail” (F) and if no phase instability is observed, the is rated as a “pass” (P), for the specified time point.

Hot temperature stability is measured by filling a 4-ounce glass vial with a sample composition. The vial is sealed and stored at 54° C. two weeks. The vial is then moved to a 25° C. environment and stored for 10 to 12 hours. The vials are then visually observed for phase stability (and may be assessed for turbidity using the Turbidity method described above). Phase instability is determined when more than one phase is visually apparent, such as a top hazy/milky phase separated from a clear bottom phase or a clear top phase that is separated from a bottom hazy/milky phase. If phase instability is observed, the sample is rated as a “fail” (F) and if no phase instability is observed, the sample is rated as a “pass” (P), for the specified time point.

### Receding Contact Angle (RCA) Method

The receding angle (receding contact angle, RCA) is the contact angle between a liquid and a solid that has already been wetted with the liquid, which occurs in the course of dewetting. In this method, the contact angle between a droplet of sample composition and a horizontal teflon-coated substrate is measured as the volume of the droplet decreases, facilitating liquid retreat from a surface that has already be wetted with the composition. Specifically, a pump is used to dispense 2 to 6 μL of sample composition onto a teflon-coated slide at 1.4 μL/s through a 27-ga blunt-tipped needle, at which point the pump is reversed, and the droplet is pulled by suction back into the needle, reducing its volume toward zero. This entire process is captured in the plane of the slide with a camera interfaced with suitable magnification and suitable lighting and contrast to elucidate the junction between droplet of composition, teflon substrate, and surrounding air. Analysis of resulting images is then used to measure the contact angle, often digitally or via the use of image analysis procedures.

Exemplary suitable apparatus for measuring RCA is a USB 3 Based Point Grey Flycapture monochrome 500 fps camera, Fluid dispense Auto syringe, auto position tip Z, Navitar 4× lens, LED back light, and FTA 1000 Controller Electric Box, or equivalents. A standard image-analysis check can be performed prior to data collection by, for example using idealized droplet profiles of “combo calibration device” (Combo Calibration Device ramé-hart instrument co. p/n 100.27-37-31-C). In this calibration device, calibrated contact angles should be as follows (±2°) A: 30° B: 60° C.: 90° D: 120°.

Continuing with the exemplary procedure, a syringe is filled with the sample, a Grey Flat tipped needle-27G OD 0.406 mm (about 0.02 in) attached, and the syringe clamped into the dispenser. A Teflon slide should be cleaned thoroughly with Dawn dish detergent and water; then dried with ethanol and nitrogen gas. The slide is binder clipped to a glass slide to ensure a flat surface. The FTA32 software settings should be set to the following:
Images before trigger: 20
Image period before trigger(s): 0.05
Total time before trigger: 1
Images after trigger: 500
Initial period after trigger(s): 0.05
Post-trigger period multiplier: 1
Last period after trigger: 0.05
Total time after trigger: 25
Camera Frame Rate: 100
Pump rate: 1.4 uL/s

Pump out liquid until the droplet is 2-6 μL in volume. Allow a few seconds for the droplet to settle on the slide, then click the pump in button to uptake the liquid. Be sure to not let the tip of the needle leave the droplet. The movie will load into the analysis software. Select the corners of the droplet with a right click and select “Store and reuse this baseline” in the Contact Angle tab. Then click “Cineloop.” Export results to Excel. If there are any extreme spikes in the contact angle or volume values, advance to that image, reselect the corners, and create a new baseline. To determine the RCA, graph the volume and contact angle over time. The contact angle, as the volume approaches 0, is the receding contact angle.

In like fashion, the receding contact angle of a total of three replicate specimens of the sample composition are analyzed. The average (arithmetic mean) of the measured receding contact angles is calculated and reported as the Receding Contact Angle to the nearest 0.1 degree.

### Cryogenic Transmission Electron Microscopy (Cryo-TEM) Method

A glow-discharged Quantifoils® grid, or equivalent, is held by tweezers inside a Vitrobot Mark IV vitrification system equilibrated to a target sample temperature (e.g., 10° C., 30° C., 54° C.) and 100% relative humidity. A drop of liquid sample of interest is applied to the grid using a glass pipette. The grid with liquid sample is blotted to remove excess liquid and subsequently plunge-frozen in liquid ethane. The resulting grid with sample is kept at or below −180° C. after preparation, during transfer to the microscope and during data collection. Images are collected using a Tecnai G2 20, or equivalent, operated at 200 kV with an Ultrascan CCD camera at low-dose conditions. At least three areas of each grid are imaged to ensure a representative qualification of the microstructure present is provided.

### Combinations

Paragraph A. A pest control composition comprising:
   a. from about 4% to about 10% by weight of the pest control composition of sodium lauryl sulfate;
   b. from about 1% to about 8% by weight of the pest control composition of a C5 to C9 hydrotropic salt;
   c. an active ingredient comprising menthol; and
   d. from about 60% to about 95% by weight of the pest control composition of water;
   wherein the composition is non-Newtonian.
Paragraph B. The pest control composition of Paragraph A, wherein the pest control composition has a first viscosity of from about 15 cP to about 1,500 cP at a shear rate of 1 sec⁻¹ measured at 15° C. and a second viscosity of from about 1 cP to about 50 cP at a shear rate of 500 sec⁻¹ measured at 15° C.
Paragraph C. The pest control composition of Paragraph B, wherein the pest control composition has a third viscosity of from about 15 cP to about 1,000 cP at a shear rate of 1 sec⁻¹ measured at 22° C. and a fourth viscosity of from about 1 cP to about 50 cP at a shear rate of 500 sec⁻¹ measured at 22° C.
Paragraph D. The pest control composition of any of Paragraphs A-C, wherein the hydrotropic salt is chosen from a salt of benzoic acid, a salt of sorbic acid, or mixtures thereof.
Paragraph E. The pest control composition of any of Paragraphs A-D, wherein the pest control composition comprises from about 0.05% to about 3% menthol, by weight of the pest control composition.
Paragraph F. The pest control composition of any of Paragraphs A-E, wherein the pest control composition comprises a ratio of hydrotropic salt to sodium lauryl sulfate of from about 0.15 to about 0.9.
Paragraph G. The pest control composition of any of Paragraphs A-F, wherein the pest control composition further comprises a pH adjusting agent selected from the group consisting of citric acid or a salt thereof, malic acid or a salt thereof, acetic acid or a salt thereof, fumaric acid or a salt thereof, humic acid or a salt thereof, and mixtures thereof.
Paragraph H. The pest control composition Paragraph G, wherein the pest control composition comprises from about 0.0001% to about 3% of the pH adjusting agent, by weight of the pest control composition.
Paragraph I. The pest control composition of any of Paragraphs A-H, wherein the pest control composition further comprises from about 1% to about 6% geraniol, by weight of the pest control composition.
Paragraph J. The pest control composition of any of Paragraphs A-I, wherein the pest control composition further comprises from about 1% to about 3% isopropyl alcohol, by weight of the pest control composition.
Paragraph K. The pest control composition of any of Paragraphs A-J, wherein the pest control composition comprises about 3% volatile organic compounds (VOCs) by weight or less.
Paragraph L. The pest control composition of any of Paragraphs A-K, wherein the pest control composition has a pH of from about 3.0 to about 11.0, preferably from about 4.8 to about 8.0, more preferably from about 5.0 to about 6.5.
Paragraph M. The pest control composition of any of Paragraphs A-L, wherein the pest control composition further comprises urea.
Paragraph N. The pest control composition of any of Paragraphs A-M, wherein the pest control composition is substantially free of synthetic pesticides, mineral oil, colorants, or a combination thereof.
Paragraph O. The pest control composition of any of Paragraphs A-N, wherein the pest control composition exhibits a turbidity of from about 2 NTU to about 40 NTU.
Paragraph P. The pest control composition of any of Paragraphs A-O, wherein the pest control composition exhibits a hydrodynamic equivalent diameter of from about 10 nm to about 50 nm.
Paragraph Q. The pest control composition of any of Paragraphs A-P, wherein the pest control composition is substantially free of gums or polymeric thickeners.
Paragraph R. A process for making the pest control composition of any of Paragraphs A-Q comprising the steps of: (i) combining sodium lauryl sulfate, the active ingredient, a solvent, water, and optionally, a pH adjusting agent; (ii) adding the hydrotropic salt; and (iii) mixing to form the pest control composition; wherein a lyotropic liquid crystalline microstructure is formed after the addition of the hydrotropic salt.
Paragraph S. A method of controlling one or more weeds comprising the steps of: (i) providing the pest control composition of any of Paragraphs A-Q; and (ii) contacting the one or more weeds with the pest control composition.
Paragraph T. The method of Paragraph S, wherein the pest control composition is a burn down herbicide.
Paragraph U. The method of Paragraph T, wherein the pest control composition disrupts root growth of the one or more weeds.
Paragraph V. The method of any of Paragraphs S-U, wherein the pest control composition can be used to control weeds in a vegetable garden.
Paragraph W. A method of controlling a pest comprising the steps of: (i) providing a pest control composition according to any one of Paragraphs A-Q; (ii) contacting the pest with the pest control composition; (iii) optionally wiping any excess pest control composition from an adjacent surface(s).

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm.”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A pest control composition comprising:
a. from about 4% to about 10% by weight of the pest control composition of sodium lauryl sulfate;
b. from about 1% to about 8% by weight of the pest control composition of a C5 to C9 hydrotropic salt;
c. an active ingredient comprising menthol; and
d. from about 60% to about 95% by weight of the pest control composition of water;
wherein the composition is non-Newtonian.

2. The pest control composition of claim 1, wherein the pest control composition has a first viscosity of from about 15 cP to about 1,500 cP at a shear rate of 1 sec⁻¹ measured at 15° C. and a second viscosity of from about 1 cP to about 50 cP at a shear rate of 500 sec⁻¹ measured at 15° C.

3. The pest control composition of claim 2, wherein the pest control composition has a third viscosity of from about 15 cP to about 1,000 cP at a shear rate of 1 sec⁻¹ measured at 22° C. and a fourth viscosity of from about 1 cP to about 50 cP at a shear rate of 500 sec⁻¹ measured at 22° C.

4. The pest control composition of claim 1, wherein the hydrotropic salt is chosen from a salt of benzoic acid, a salt of sorbic acid, or mixtures thereof.

5. The pest control composition of claim 1, wherein the pest control composition comprises from about 0.05% to about 3% menthol by weight of the pest control composition.

6. The pest control composition of claim 5, wherein the pest control composition further comprises from about 1% to about 6% geraniol by weight of the pest control composition.

7. The pest control composition of claim 1, wherein the pest control composition comprises a ratio of hydrotropic salt to sodium lauryl sulfate of from about 0.15 to about 0.9.

8. The pest control composition of claim 1, wherein the pest control composition has a pH of from about 3.0 to about 11.0.

9. The pest control composition of claim 1, wherein the pest control composition is substantially free of synthetic pesticides, mineral oil, colorants, or a combination thereof.

10. The pest control composition of claim 1, wherein the pest control composition exhibits a hydrodynamic equivalent diameter of from about 10 nm to about 50 nm.

11. A pest control composition comprising:
a. from about 4% to about 10% by weight of the pest control composition of sodium lauryl sulfate;
b. from about 1% to about 8% by weight of the pest control composition of a C5 to C9 hydrotropic salt;
c. an essential oil chosen from cornmint oil, peppermint oil, or combinations thereof; and
d. from about 60% to about 95% by weight of the pest control composition of water;
wherein the pest control composition exhibits a ratio of a first viscosity at a shear rate of 1 sec⁻¹ to a second viscosity at a shear rate of 500 sec⁻¹ measured at 15° C. of at least 1.5.

12. The pest control composition of claim 11, wherein the hydrotropic salt is chosen from a salt of benzoic acid, a salt of sorbic acid, or mixtures thereof.

13. The pest control composition of claim 11, wherein the pest control composition further comprises from about 0.0001% to about 3% of a pH adjusting agent by weight of the pest control composition.

14. The pest control composition of claim 11, wherein the pest control composition further comprises from about 1% to about 3% isopropyl alcohol by weight of the pest control composition.

15. The pest control composition of claim 11, wherein the pest control composition comprises from about 1% to about 6% geraniol by weight of the pest control composition.

16. The pest control composition of claim 11, wherein the pest control composition exhibits a turbidity of from about 2 NTU to about 40 NTU.

17. The pest control composition of claim 11, wherein the first viscosity is from about 15 cP to about 1,500 cP and the second viscosity is from about 1 cP to about 50 cP.

18. The pest control composition of claim 11, wherein the pest control composition further comprises urea.

19. A method of controlling one or more weeds comprising the steps of: (i) providing the pest control composition of claim 1; and (ii) contacting the one or more weeds with the pest control composition.

20. The method of claim 19, wherein the pest control composition disrupts root growth of the one or more weeds.
